(19) United States
(12) Patent Application Publication
(10) Pub. No.: US 2021/0161307 A1
(43) Pub. Date: Jun. 3, 2021

(54) PORTABLE CHAIR INSERT

(71) Applicants: Jeri Dean, Lahaina, HI (US); Jina Miyamoto, Lahaina, HI (US)

(72) Inventors: Jeri Dean, Lahaina, HI (US); Jina Miyamoto, Lahaina, HI (US)

(21) Appl. No.: 17/176,098

(22) Filed: Feb. 15, 2021

Related U.S. Application Data
(63) Continuation-in-part of application No. 16/255,720, filed on Jan. 23, 2019.
(60) Provisional application No. 62/624,955, filed on Feb. 1, 2018.

(51) Int. Cl. A47D 1/10; A47C 7/62; A47D 15/00; A47C 7/02; A47C 7/18

(52) U.S. Cl. CPC A47D 1/10; A47C 7/622; A47C 7/18; A47C 7/021; A47D 15/005

(57) ABSTRACT

A portable chair; the portable chair includes a seat-panel, a first side panel, a second side panel, a rear panel, and a front panel. The portable chair is insertable into a shopping cart seat or a highchair or other public seating. And is designed for use by infants or small children. The portable chair provides a soft collapsible child seat insert for shopping carts and highchairs designed to offer additional comfort and support for an infant.

### CROSS REFERENCE TO RELATED APPLICATIONS

The present application is related to and claims priority to U.S. Non-provisional patent application Ser. No. 16/255,720, filed on Jan. 23, 2019, pending, which is related to and claims priority to U.S. Provisional Patent Application No. 62/624,955 filed Feb. 1, 2018, both of which are incorporated by reference in their entirety.

### FIELD

The present invention generally relates to the field of infant accessories and relates to a portable chair insert accessory.

### BACKGROUND

The following includes information that may be useful in understanding the present disclosure. It is not an admission that the information provided is prior art nor material to the described or claimed inventions, nor that any publication or document specifically or implicitly referenced is prior art.

Children sitting in a shopping cart or highchair seat may be at risk for falling out of the seat, especially if the child is undersized. Infants and toddlers can contract infectious germs and bacteria while sitting in public seats, leading to parents having to take them to a doctor, administer medication, etc. Without a way to secure and sanitize public seats for children, parents may be wary of taking their children to a grocery store or restaurant. A suitable solution is desired.

U.S. Pat. No. 4,889,388 to Sherry R. Hime relates to a transportable seat insert especially adapted for infants. The described transportable seat insert especially adapted for infants includes a transportable, machine washable, collapsible, compact, lightweight seat insert for supporting a human in a sitting position. The insert includes a box shaped, flexible, resilient, padded frame including a back wall, a pair of side walls, a bottom wall, and a front wall having a pair of openings for accommodating the human's legs. The seat insert further includes a pillow adapted to be selectively disposed above and adjacent to the back wall and attached to the back wall with VELCRO fasteners.

### BRIEF SUMMARY OF THE INVENTION

because of the foregoing disadvantages inherent in the known infant accessory art, the present disclosure provides a novel portable chair insert. The general purpose of the present disclosure, which will be described subsequently in greater detail, provides a soft collapsible child seat insert for shopping carts and highchairs designed to offer additional comfort and support for an infant. The child seat insert may offer a more sanitary option for parents or guardians when placing children into public seats. Further, the child seat insert may fold for transportation, ensuring the same can fit inside a backpack, baby bag, etc.

A portable chair is disclosed herein. The portable chair includes a seat panel which may be configured for placement over the seat of the structure frame. A first side panel may be included and may extend upwardly from the seat panel at a first side of the seat panel. Similarly, a second side panel may be included and may extend upwardly from the seat panel at a second side of the seat panel; the second side panel being opposite the first side panel. Further, a back panel may be included and may extend upwardly from the seat panel at a rear of the seat panel, the back panel may be configured to rest against the rear support section of the structure frame. In addition, a front panel may be included. The front panel may include a horizontal member and a vertical member extending from a midsection of the horizontal member. The horizontal member may attach to the first side panel at a first horizontal end and attached to the second side panel at a second horizontal end.

The vertical member may attach to the midsection of the horizontal member at a first vertical end and attached to the seat panel at a second vertical end. Further, the horizontal member and the vertical member may together define leg openings configured to allow legs of the user (occupant) to extend therethrough. Besides this, the horizontal member may include at least one attachment configured to attach the front panel to the front support section of the frame structure.

A method of using portable chair is also disclosed. The method of using portable chair may comprise the steps of providing the portable chair as above; placing the seat panel over the seat of the structure frame; attaching the front panel to the front support section via the at least one attachment means; and securing a user (occupant) within the portable chair.

A portable chair is disclosed. It has attachments configured to connect to a user supporting structure which includes public seating. The user supporting structure has a rear support section with a top end and a seat separated from the top end by a distance. The portable chair also contains a seat panel; first and second side panels extending upwardly from the seat panel; a back panel configured to contact the rear support section and extending up from the seat panel; a front panel including a horizontal member having first and second ends separated from the first and second side panels by vertical seams and a vertical member having first and second ends separated from the horizontal member by a horizontal seam and the seat panel by a seam.

In versions the back panel extends higher than the distance between the top of the public seat and the seat portion of the public seat. In these or other versions, the back panel extends from the seat panel further than the side panels extend from the seat panel.

The portable chair has padding. In some versions, the seat panel, the horizontal member, and the vertical member are padded. Sometimes the padding is separated by seams, such as vertical or horizontal seams. In some padded versions, the back panel padding is contiguous.

Some versions include one or more flaps to connect the horizontal member to the public seating, sometimes by wrapping around the public seating. And some versions do not include a removable pillow.

To summarize the invention, certain aspects, advantages, and novel features of the invention have been described herein. Not necessarily all such advantages need to be achieved under any one embodiment of the invention. Thus, the invention may be embodied or carried out to achieve or optimize one advantage or group of advantages without achieving other advantages. The features of the invention believed to be novel are pointed out and distinctly claimed in the concluding portion of the specification. These and other features, aspects, and advantages of the present invention will become better understood referring to these drawings and detailed description.

### BRIEF DESCRIPTION OF THE DRAWINGS

The figures which accompany the written portion of this specification illustrate embodiments and methods of use for the present disclosure, a portable chair insert, constructed and operative according to the teachings of the present disclosure.

FIG. 1A is a side rear perspective view of the portable chair during an ‘in use’ condition.

FIG. 1B is a side front perspective view of the portable chair during an ‘in use’ condition.

FIG. 2A is a front perspective view of the portable chair of FIG. 1B.

FIG. 2B is a side rear perspective view of the portable chair of FIG. 1B.

FIG. 3 is a side rear perspective view of the portable chair of FIG. 1A.

FIG. 4 is a flow diagram illustrating a method of use for the portable chair.

The embodiments of the present invention will be described with the appended drawings, wherein like designations denote like elements.

### DETAILED DESCRIPTION

A portable chair insert is generally disclosed. The portable chair insert may resemble a booster seat with sides extending up below a child's arms, providing support and ensuring the child does not fall out of the chair sides. The portable chair insert may use front straps designed to wrap around a bar on a shopping cart, highchair, or other public seating for optimal securement, preventing the insert from falling out of the chair. For this disclosure, “public seating” is any seating outside of the user's home.

The portable chair insert may include pockets for storing small personal items, child's toys, bottles, sippy cups, and more. A protective strap may also be applied, allowing for additional protection against germs and bacteria commonly present on public furniture. The seat may be made from nylon or polyester or organic cotton and foam material and include a webbing strap to secure the baby to the seat. The seat may further be collapsible. Further to this, a strap may be included at a top of the portable chair insert to attach the portable chair insert to the shopping cart or highchair. In addition, ties may be included each side of the portable chair insert to further secure the portable chair insert to the shopping cart or highchair or other public seating. Loops may also be added to the protective strap to attach rattles or toys.

The pockets might also be made of material or organic material and may include zipper or buttons to close. The portable chair insert may also include a detachable coin purse or clutch to fit inside pockets. Exact size, measurement, construction, and design specifications may vary upon manufacturing. Parents may unfold the portable chair insert and place it within the public seating. The child may then be placed within the insert and secured using the webbing strap. The seat may be intended to accommodate children from 4 24 months, keeping him or her safe and giving a parent or guardian peace of mind while shopping, in a restaurant, and more.

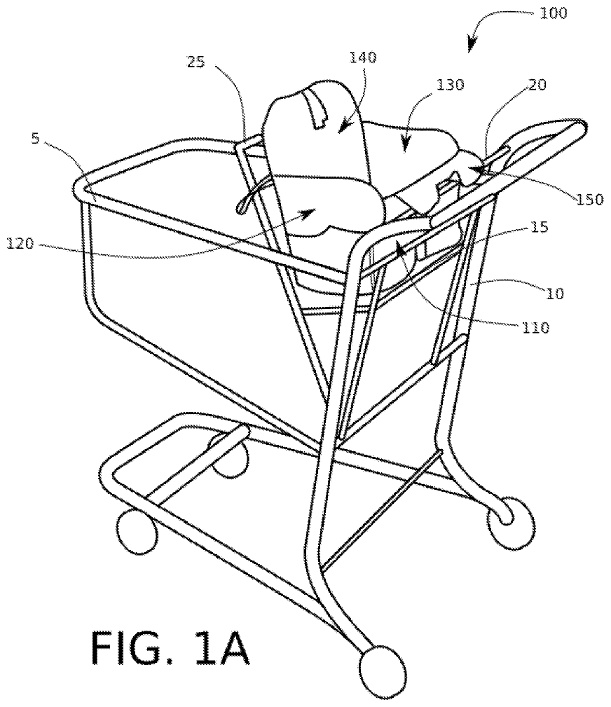

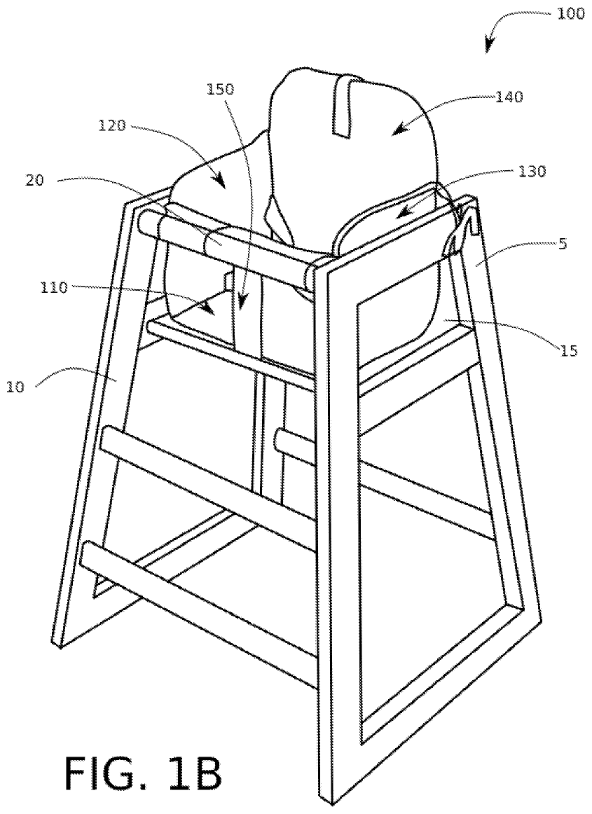

FIGS. 1A-3 show various views of a portable chair 100.

FIGS. 1A, 1B show a portable chair 100 during an ‘in use’ condition 150. The portable chair 100 may be inserted into public seating or a user supporting structure 5. The user supporting structure 5 may include a structure frame 10 having a seat 15, a front support section 20, and a rear support section 25. The front support section 20 and the rear support section 25 being relative to the user when the user is seated within the user supporting structure 5. As shown in FIG. 1A, the user supporting structure 5 may be a shopping cart. As shown in FIG. 1B, the user supporting structure 5 may be a highchair. Other types of seating are contemplated despite not being illustrated in the figures. The portable chair 100 may include a seat panel 110, a first side panel 120, a second side panel 130, a back panel 140, and a front panel 150.

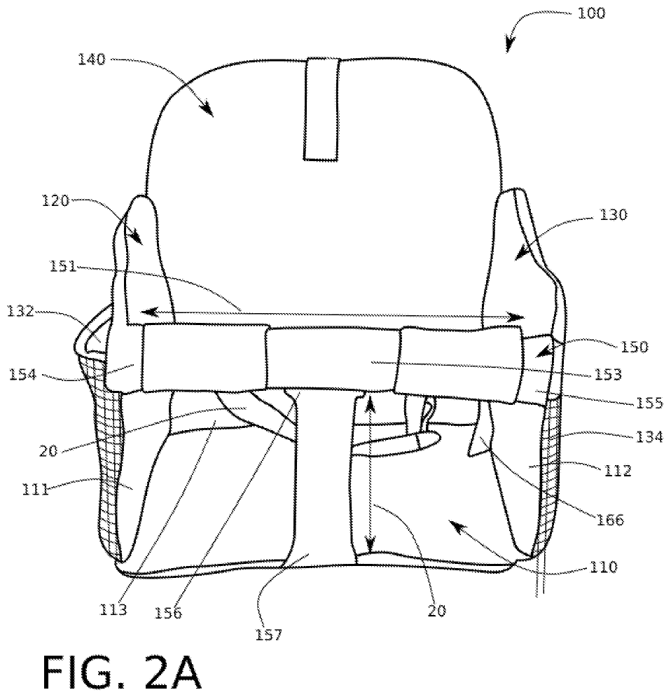

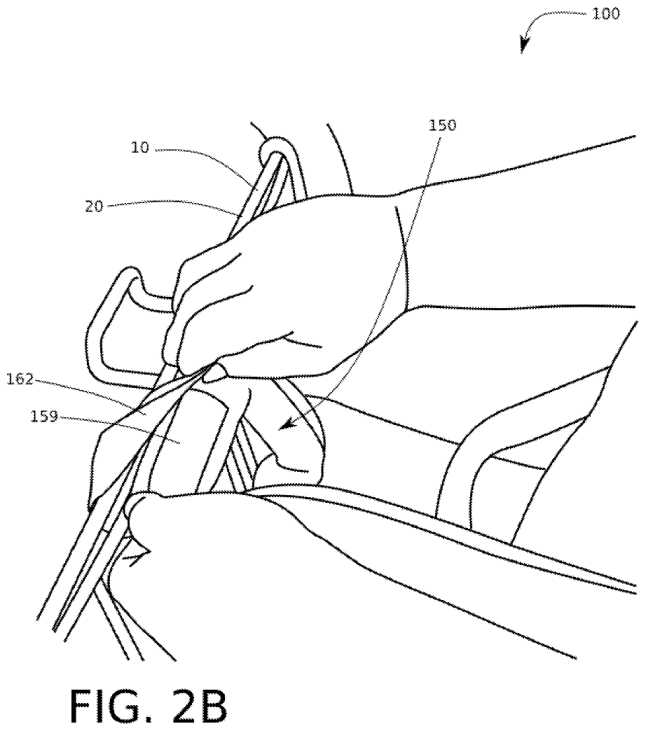

FIGS. 2A, 2B show front and side rear perspective views of the portable chair 100 of FIG. 1B. As shown, the seat panel 110 may be placed over the seat 15 (FIGS. 1A, 1B) of the structure frame 10. The first side panel 120 may extend upwardly from the seat panel 110 at a first side 111 of the seat panel 110, and similarly, the second side panel 130 may extend upwardly from the seat panel 110 at a second side 112 of the seat panel 110. The second side panel 130 may be opposite the first side panel 120. The first side panel 120 may include a first storage means 132, and similarly, the second side panel 130 includes a second storage means 134. Preferably, the first storage means 132 and the second storage means 134 are a first pocket and a second pocket, respectively. Further, a back panel 140 may extend upwardly from the seat panel 110 at a rear 113 of the seat panel 110. The back panel 140 may be configured to rest against the rear support section 25 (FIGS. 1A, 1B) of the structure frame 10. In some versions, back panel 140 extends higher than either of the side panels. In some versions, the top edge of the back panel 140 extends between 6-24, 8-20, or 9-18 inches above the seat panel.

In addition, a harness 166 may be provided on the portable chair 100. The harness 166 may be configured to secure a user to the portable chair 100. In one embodiment, the harness 166 may include two arm straps. In another embodiment, the harness 166 may include one strap configured to secure around a waist of the user.

Preferably, the seat panel 110, the first side panel 120, the second side panel 130, the back panel 140 and the front panel 150 may include padding to further protect and increase comfort for the user. In one embodiment, the padding may comprise a foam material. Other padding materials are contemplated. Examples include wool, polyester fiber, etc. The padding may be covered by a material which may be comfortable and easily washable. Examples of the material may be nylon, polyester, cotton, etc. In versions, padding excludes quilted material. In some of the non-quilted material versions, material other than quilted material is selected because quilted material does not provide adequate stiffness to support the user. In some versions, the portable chair includes a secondary insert. The secondary insert can be patted or unpadded. It is typically washable.

The front panel 150 may include a horizontal member 151 and a vertical member 152 extending from a midsection 153 of the horizontal member 151. The horizontal member 151 may attach to the first side panel 120 at a first horizontal end 154 and attached to the second side panel 130 at a second horizontal end 155. The vertical member 152 may attach to the midsection 153 of the horizontal member 151 at a first vertical end 156 and attached to the seat panel 110 at a second vertical end 157. The horizontal member 151 and the vertical member 152 together may define leg openings 158 configured to allow legs of the user to extend therethrough. In some versions, horizontal or vertical seems a separate the horizontal member from the sides, the vertical member from the horizontal member, or the vertical member from the seat panel. In these or other versions, these seams bound the padding.

Further, the horizontal member 151 may include at least one attachment 159 configured to attach the front panel 150 to the front support section 20 of the structure frame 10. Besides this, the horizontal member 151 may include at least one flap 162 configured to attach the front panel 150 to the front support section 20. Preferably, the at least one flap 162 may include hook and loop fastener. Other fasteners are contemplated, such as snap fasteners, buttons, hook and eye fasteners, etc. In addition, the at least one flap 162 may comprise 2 or exactly 2 flaps 162.

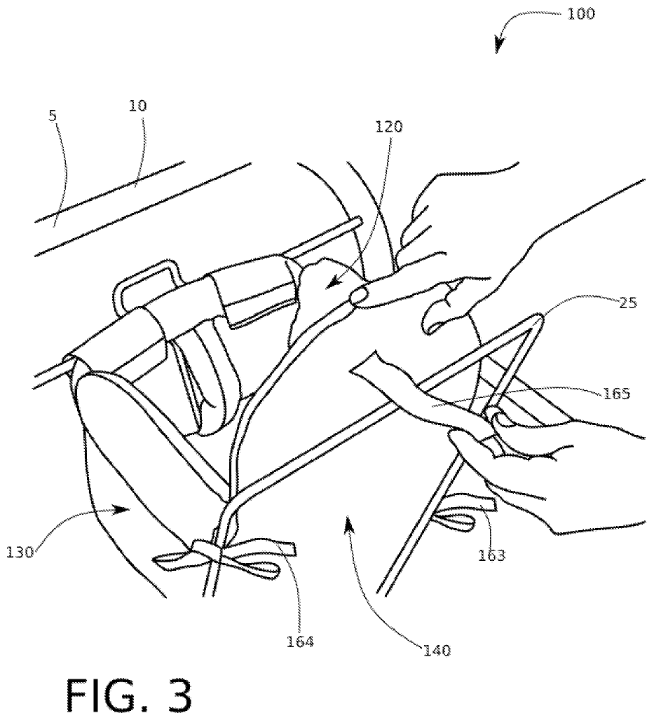

FIG. 3 shows a side rear perspective view of the portable chair 100 of FIG. 1A. As shown here, a first fastener 163 may attach to the first side panel 120 and attach the first side panel 120 to the user supporting structure 5. Similarly, a second fastener 164 may attach to the second side panel 130 and attach the second side panel 130 to the user supporting structure 5. The first fastener 163 and the second fastener 164 may be a first tie and a second tie, respectively. In this embodiment, the first fastener 163 may attach to the first side panel 120 and may tie the first side panel 120 to the user supporting structure 5. Likewise, the second fastener 164 may attach to the second side panel 130 and may tie the second side panel 130 to the user supporting structure 5. As shown here, the first fastener 163 and the second fastener 164 may attach the first side panel 120 and the second side panel 130 to the rear support section.

A third fastener 165 may attach to the back panel 140 of the portable chair 100. In one embodiment, the third fastener 165 may be a strap. The strap may include hook and loop fastener to attach the back panel 140 to the rear support section 25. It should be appreciated that other fasteners are contemplated for the first fastener 163, the second fastener 164, and the third fastener 165.

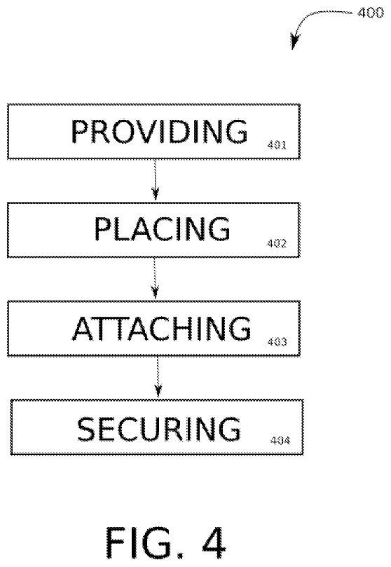

FIG. 4 is a flow diagram illustrating a method of using a portable chair 400. As illustrated, the method of using a portable chair 400 may include the steps of providing 401 the portable chair as above; placing 402 the seat panel over the seat of the structure frame; attaching 403 the front panel to the front support section via the at least one attachment means; and securing 404 a user within the portable chair.

the steps described in the method of use can be carried out in many orders according to user preference.

Unless defined otherwise, all technical and scientific terms used in this document have the same meanings as commonly understood by one skilled in the art to which the disclosed invention pertains. Singular forms—a, an, and the—include plural referents unless the context indicates otherwise. Thus, a reference to “fluid” refers to one or more fluids, such as two or more fluids, three or more fluids, etc. When an aspect is said to include a list of components, the list is representative. If the component choice is limited explicitly to the list, the disclosure will say so. Listing components acknowledges that exemplars exist for each component and any combination of the components—including combinations that exclude any one or any combination of the listed components. For example, “component A is chosen from A, B, or C” discloses exemplars with A, B, C, Aft AC, BC, and ABC. It also discloses (AB but not C), (AC but not B), and (BC but not A) as exemplars, for example. Combinations that one of ordinary skill in the art knows to be incompatible with each other or with the components' function in this device are excluded from this device, in some exemplars.

When an element or layer is called “on”, “engaged to”, “connected to” or “coupled to” another element or layer, it may be directly on, engaged, connected, or coupled to the other element or layer, or intervening elements or layers may be present. When an element is called “directly on”, “directly engaged to”, “directly connected to”, or “directly coupled to” another element or layer, there may be no intervening elements or layers present. Other words used to describe the relationship between elements should be interpreted in a like fashion (e.g., “between” versus “directly between”, “adjacent” versus “directly adjacent”, etc.).

Although the terms first, second, third, etc. may describe various elements, components, regions, layers, or sections, these elements, components, regions, layers, or sections should not be limited by these terms. These terms may distinguish only one element, component, region, layer, or section from another region, layer, or section. Terms such as “first”, “second”, and other numerical terms do not imply a sequence or order unless indicated by the context. Thus, a first element, component, region, layer, or section discussed below could be termed a second element, component, region, layer, or section without departing from this disclosure.

Spatially relative terms, such as “inner”, “outer”, “beneath”, “below”, “lower”, “above”, “upper” may be used for ease of description to describe one element or feature's relationship to another element or feature as illustrated in the figures. Spatially relative terms may be intended to encompass different orientations of the device in use or operation and the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors interpreted.

The description of the exemplars has been provided for illustration and description. It is not intended to be exhaustive or to limit the invention. And various exemplars have been described above. For convenience's sake, combinations of aspects composing invention exemplars have been listed so that one of ordinary skill in the art may read them exclusive of each other when they are not necessarily intended to be exclusive. But a recitation of an aspect for one exemplar discloses its use in all exemplars in which that aspect can be incorporated without undue experimentation. Likewise, a recitation of an aspect as composing part of an exemplar is a tacit recognition that a supplementary exemplar excludes that aspect explicitly. All patents, test procedures, and other documents cited in this specification are incorporated by reference if this material follows this specification and for all jurisdictions in which such incorporation is permitted. The same may also be varied. Such variations are not a departure from the invention, and all such modifications are included within the invention's scope.

While particular exemplars of the present invention have been shown and described, it will be obvious to those skilled in the art that changes and modifications can be made without departing from the exemplars of this invention in its broader aspects and, therefore, the appended claims are to encompass within their scope all such changes and modifications as fall within the true, intended, explained, disclose, and understood scope and spirit of this invention's many exemplars and alternative descriptions.

Some exemplars recite ranges. When this is done, it discloses the ranges as a range and disclose each point within the range, including endpoints. For those exemplars that disclose a specific value or condition for an aspect, supplementary exemplars exist that are otherwise identical but that specifically exclude the value or the conditions for the aspect.

The following description of several exemplars describes non-limiting examples that further illustrate the invention. No titles of sections contained herein, including those appearing above, are limitations on the invention, but rather they are provided to structure the illustrative description of the invention provided by the specification.

Any methods and materials similar or equivalent to those described in this document can be used in the practice or testing of the present invention. This disclosure incorporates by reference all publications mentioned in this disclosure and the information disclosed in the publications.

This disclosure discusses publications only to facilitate describing the invention. Their inclusion in this document is not an admission they are effective prior art to this invention, nor does it indicate that their dates of publication or effectiveness are as printed on the document.

What is claimed is:

1. A portable chair comprising:
attachments configured to connect to a user supporting structure wherein the user supporting structure has a rear support section with a top end and a seat separated from the top end by a distance;
a seat panel;
first and second side panels extending upwardly from the seat panel;
a back panel configured to contact the rear support section and extending up from the seat panel;
a front panel including
a horizontal member having first and second ends separated from the first and second side panels by vertical seams
and
a vertical member having first and second ends separated from the horizontal member by a horizontal seam and the seat panel by a seam.

2. The portable chair of claim 1, wherein the back panel has a height greater than the distance.

3. The portable chair of claim 1, wherein the back panel extends from the seat panel further than the side panels extend from the seat panel.

4. The portable chair of claim 3, wherein the seat panel, the horizontal member, and the vertical member are padded.

5. The portable chair of claim 2, wherein the horizontal member padding and the vertical member padding are separated by a horizontal seam.

6. The portable chair of claim 5, wherein the horizontal member padding ends at vertical seams.

7. The portable chair of claim 6, wherein the horizontal member includes at least one flap configured to wrap around the user supporting structure.

8. The portable chair of claim 7, wherein the horizontal member includes at least another flap configured to wrap around the user supporting structure.

9. The portable chair of claim 8, wherein the flaps secure the horizontal member to the user supporting structure.

10. The portable chair of claim 9, wherein the back panel padding is contiguous.

11. The portable chair of claim 10 further comprising a storage area.

12. The portable chair of claim 11, wherein the storage area is a pocket.

13. The portable chair of claim 12 further comprising a harness configured to secure a user to the portable chair.

14. The portable chair of claim 13, wherein the padding comprises a foam material.

15. The portable chair of claim 14 wherein the chair does not comprise a removable pillow.
